(19) United States
(12) Patent Application Publication
(10) Pub. No.: US 2005/0095338 A1
(43) Pub. Date: May 5, 2005

(54) Food product containing gel capsules or tablets

(75) Inventors: Paulo Fernandes, Amiens (FR); Lucien Lespagnol, Aubigny (FR)

Correspondence Address: Sanjay Agrawal;Nestle Purina 11T, 1 Checkerboard Square, St Louis, MO, 63164-0001, US

(73) Assignee: Nestec S.A., Vevey (CH)

(21) Appl. No.: 10/499,408

(22) PCT Filed: Dec. 13, 2002
(86) PCT No.: PCT/EP02/14287

(30) Foreign Application Priority Data
Dec. 20, 2001 (EP) 01205019.1

(51) Int. Cl. A23L 1/05

(52) U.S. Cl. 426/573

(57) ABSTRACT

The present invention concerns a food or pet food product containing up to 50% gel capsules or tablets based on alginate, pectate or a mixture of both and comprising oil, vitamins, amino-acids, proteins, minerals, colorants, flavors and/or specifically targeted functional ingredients such as probiotic microorganisms, bioactive molecules, said food product being taken in the group consisting of chilled, dried retorted and UHT-products.

The present invention concerns a food or a pet food product containing nutritional/ nutraceutical gel capsules or tablets.

The basic concept of the application “nutritional/nutraceutical carriers” means a food which is based on knowledge concerning the relationship between food components and health. Functional foods can be potentially more efficient by maintaining the health of humans and pets.

Addition of oil, vitamins, minerals, among others, can play an important role in making foods nutritionally complete. Designated to meet the needs of medical foods, foods for special needs, and nutraceutical products, these nutrient systems assure accurate potency while nutritional requirements and consistency are maintained. They make addition of oil (for energy requirements), vitamins, minerals, amino acids, and nucleotides to food easy and convenient, eliminating the need to scale and inventory each ingredient separately. It is also important to note that encapsulation technology can be used due to the following advantages:
(a) innovative presentation of nutritional ingredients / gel caps with different colors, shapes and size diameters;
(b) nutritional value is visually perceived by the consumer which represent an added value to final products;
(c) gel capsules/tablets can be used to protect nutrients from outside environment as well as potential reactors to develop reactions between nutrients (e.g. specific flavors, etc).
(d) to mask unpleasant odors and flavors in custom vitamin and mineral premixes and to prevent ingredient interactions that can decrease stability.
(e) Extra-value ingredient. Two for the price of one means extra added value to final products.

The present invention concerns a food or pet food product containing up to 50% gel capsules or tablets based on alginate, pectate or a mixture of both and comprising oil, vitamins, amino-acids, proteins, minerals, colorants, flavors and/or specifically targeted functional ingredients such as probiotic microorganisms, bioactive molecules, said food product being taken in the group consisting of dried, chilled, retorted and UHT-products.

Under food product in the present specification, it is to be understood human foods and petfoods.

In addition to the alginate and pectate, it is also possible to have a minor addition of other hydrocolloids, such as carraghenate, gellan or agar. In this case, the amount of these minor ingredients does not exceed 10% of the total alginate, pectate and minor ingredients.

The technique, which is used for preparing the gel capsules, is normally encapsulation (coating). In the present specification, the tablets are prepared according to the entrapment technique. It is also possible according to the invention to have the preparation of tablets, according to the entrapment principle, said tablets being then coated, so that finally they has to be considered as capsules.

It is possible according to the invention to have a high level of gel capsules in the final product. Preferably, the content of the gel capsules is comprised between 0 and 12%. The percentages in the specification are given based on the final product and in weight.

According to a first embodiment, it is a chilled product, which is taken in the group consisting of dairy or non dairy products. In the case of dairy products, it can be yoghurt, mousse and dessert cream. In the case of non dairy products, it can be soy or tofu products.

According to the second embodiment, it is a dried or retorted product, taken in the group consisting of meat and jelly, fish and jelly, meat, jelly, meat based vegetables. This is a typical example for the petfood area. Among the raw materials used, meat or meat by-products are all the fleshy parts of slaughtered hot-blooded animals, in the fresh state or preserved by a suitable treatment, and all the products and by-products resulting from the conversion of the body or of the parts of the body of hot-blooded animals. By meat is meant, in particular, the meat of chicken, rabbits, cattle or sheep, and offal. By offal, is meant both lung lobes and livers or kidneys. By meat by-products is meant the meal obtained from carcasses of the aforementioned animals. In the present specification, fish and fish by-products are meant fish or parts of fish, in the fresh state or preserved by a suitable treatment, as well as the by-products of their conversion. Salmon, sardines or tuna may be used as fish and fish meal may be used as by-products.

In a typical retorted petfood composition, the final product is composed of 50% fish or meat and 50% jelly. The gel capsules or tablets partially replace the fish, so that, it is a target to have a nutritionally final product containing 38-45% fish or meat, 50% jelly and 5-12% gel capsules or tablets.

According to a third embodiment, it is an UHT product taken in the group consisting of milk-based beverage, soya-based beverage, soft drink.

The gel capsules or tablets present in the food composition can be spheric or non spheric. They have normally a diameter of up to 20 mm, preferably comprised between 0.1 and 5 mm.

Typically, the gel capsules or tablets have the following composition: they contain up to 50% oil, up to 15% of calcium salt, up to 3% of a vitamin-mineral premix on a wet basis. The calcium salt is taken in the group consisting of tricalcium phosphate, calcium chloride, calcium sulphate. The oil used is taken in the group consisting of vegetal or animal oil such as palm oil, soya oil, sunflower oil, pork or beef tallow.

It is also possible according to the invention to have gel capsules or tablets with a second coating or encapsulation.

Gel entrapment is one of the most used encapsulation techniques because of its mildness, ease of operation and applicability. An hydrocolloid capsule containing nutrients (e.g.:premix: vitamins & minerals, colorants, oil, among others . . . ) is an example of liquid/nutrient encapsulated in a spherical or non spherical polymer membrane.

The methods for making heat-stable gel capsules/tablets using either alginate or low methoxyl pectin (pectate) are following:
(a) mixing of aqueous solution of alginate/pectate+tspp with blend of oil+vitamins+minerals+colorants+flavors, etc., in order to have a stable liquid emulsion. The gel capsules are obtained by dropping the stable liquid emulsion into a calcium chloride solution (or equivalent), and instantaneous alginate gel capsules are obtained;
(b) mixing of aqueous solution of the alginate/pectate+tspp with blend of oil+vitamins+minerals+colorants+flavors, etc, in order to have a liquid stable emulsion. Some food ingredients can be added either in the frozen or dry powder forms (in this case we refer as dispersion). After, we proceed to the grinding (in an emulsifier) of the liquid stable emulsion/dispersion, calcium sulphate solution (or equivalent) is injected into the emulsifier at position of cutting system, and the final emulsion is poured into a tray or mould recepient. The gelation starts in 3-5 minutes and cutting is possible after 7-10 minutes. Cutting of the gel capsules/tablets.

Both process (a) and (b) are providing gel capsules/tablets stable to retorting at 125° C. during 60 minutes.

The main problem found was that when mixing the alginate/pectate solution with the mix containg oil, vitamin-mineral premix and up to 10% triCa phosphate weak gels were almost instantaneously formed. It was found that by adding sequestrant agents this pre gelation phenomena could be avoided.

After preparation of gel capsules/tablets as mentioned above, a double coating/encapsulation can be envisaged. It corresponds to the immersion of the gel capsules/tablets in a solution of alginate, pectate or both, and after collection of the gel capsules/tablets, these are immersed in a calcium chloride solution or equivalent.

It is also possible according the invention to color the gel capsules/tablets so that the consumer can visually perceive said capsules.

The prepared gel capsules are then mixed with the corresponding product. In the chilled area, the yoghurt is mixed with the capsules and an aseptical filling takes place. In the retorted area, taking in account that the gel capsules support the sterilization, the mixing is made with the meat or the fish, then the filling in the can, closing of said can and a passage in the sterilisation area. Concerning the UHT, the mix of the gel capsules with the considered beverage flows through the UHT system and then the aseptic filling takes place.

To illustrate the above mentioned applications, examples of formula and processes are presented.

### EXAMPLE 1

Alginate Capsule/Tablet 40% Soya Oil

1.5% alginate, 0.5% Tetra sodium pyrophosphate is dispersed in 45.5% water at room temperature for 2 minutes in a dispersor.

Then, 40% soya oil, 2% vitamin/mineral premix, 10% triCa phosphate and 0.5 lecithin+colorant and minor ingredients are dispersed under strong agitation for 3 minutes in a disperser. The alginate/tspp solution is added to the oil mix under strong agitation for 3 minutes. The obtained emulsion is dropped into a 2% CaCl2 solution, resulting in an instantaneous gel capsule formation. The gel capsules are collected. Then, the gel capsules are mixed with fish/meat flakes and blended with gravy or jelly at about

50/50 mixing ratio and canning the food. The canned foods were retorted at 125° C. for 1 hour.

### EXAMPLE 2

Alginate Capsule/Tablet 40% Beeftallow Oil

1.5% alginate, 0.5% Tetra sodium pyrophosphate are dispersed in 45.5% water at 80° C. for 2 minutes in a dispersor. 40% Beef tallow oil is melted in a water bath. A dispersion of said oil, 2% vitamin/mineral premix, 10% triCa phosphate and 0.5% lecithin+colorant and minor ingredients is prepared under strong agitation for 3 minutes in a dispersor.

The oil mix (52° C.) is blended with alginate/TSPP (80° C.) and final temperature of emulsion is about 60-65° C. The emulsion obtained is dropped into a 2% CaCl2 solution, in which instantaneous gel capsule formation occurs. The gel capsules are collected. Then, the gel capsules are mixed with fish/meat flakes and blended with gravy or jelly at about 50/50 mixing ratio and canning the food. The canned foods were retorted at 125° C. for 1 hour.

### EXAMPLE 3

Alginate Capsule/Tablet 30% Sunflower Oil (Double Coating+)

1.5% alginate, 0.5% Tetra sodium pyrophosphate are dispersed in 58.5% water at room temperature for 2 minutes in a dispersor. Then, 30% soya oil, 1.5% vitamin/mineral premix, 7.5% triCa phosphate and 0.5 lecithin+colorant and minor ingredients are dispersed under strong agitation for 3 minutes in a dispersor. The alginate/tspp solution is added to the oil mix under strong agitation for 3 minutes. The obtained emulsion is dropped into a 2% CaCl2 solution, resulting in an instantaneous gel capsule formation. The gel capsules are collected and further dropped into a 0.5% alginate solution. The gel capsules are recollected and dropped into a 2% CaCl2 solution, in which instantaneous double gel capsule formation occurs (if needed these two steps are repeated).

Then, the gel capsules are mixed with fish/meat flakes and blended with gravy or jelly at about 50/50 mixing ratio, canning the food. The canned foods were retorted at 125° C. for 1 hour. Instead of mixing the gel capsules with flakes and gravy, the gel capsules may be dried to decrease/control the humidity at their surface. Then, the gel capsules are mixed with dry petfood (e.g. pellets) at about 10/90 mixing ratio. The final product is packed.

### EXAMPLE 4

Pectate Capsule/Tablet 15% Soya Oil

2.5% pectate+0.5% tetra sodium pyrophosphate are dispersed in 59.5% water at 80° C. for 3 minutes in a dispersor.

Then, 15% Soya oil, 1% vitamin-mineral premix, 5% dry ingredient (e.g. carrot powder), 5% tricalcium phosphate+minor ingredients are added to pectate/TSPP solution in the preceding dispersor. Said oil/premix/triCa+0.5% lecithin and 3% potato starch are dispersed under strong agitation for 3 minutes in a dispersor. There is formation of an emulsion. The stable liquid emulsion is grinded using an emulsifier. Calcium sulphate solution (1.5% CaSO4.2H2O, 0.016 xanthan gum, 6.48 water) is injected into the emulsifier at level of cutting system. Then, the final emulsion is poured into a tray or mould recipient. The gelation starts in 3-5 minutes and cutting is possible after 7-10 minutes. Cutting of gel capsules/tablets.

Then, the gel capsules are mixed with fish/meat flakes and blended with gravy or jelly at about 50/50 mixing ratio, canning the food. The canned foods were retorted at 125° C. for 1 hour.

The gel capsules may also be collected and dropped into a 0.5% alginate solution. The gel capsules/tablets are recollected and dropped into a 2% CaCl2 solution, in which instantaneous gel capsule formation occurs. These steps are repeated if necessary. Then, the gel capsules/tablets are mixed with fish/meat flakes and blended with gravy or jelly at about 50/50 mixing ratio, canning the food. The canned foods were retorted at 125° C. for 1 hour.

1. A food product comprising at least one of a gel capsule and a tablet wherein said gel capsule and said tablet consists of at least one of an alginate, a pectate, vitamins, amino-acids, proteins, minerals, colorants, flavors, probiotic micro-organisms, and bioactive molecules.

2. A food product according to claim 1 wherein said food product comprises from about 50% to about 99% of a retorted food product and from about 1% to about 50% of at least one of said gel capsule and said tablet.

3. A food product according to claim 2 wherein said retorted product consists of at least one of meat, a meat by-product, fish, a fish by-product, salmon, sardines, tuna, chicken, rabbit, cattle, sheep, and offal.

4. A food product according to claim 2 wherein said retorted food product comprises at least about 50% meat and 50% jelly.

5. A food product according to claim 2 wherein said retorted pet food product comprises at least about 50% fish and about 50% jelly.

6. A food product according to claim 2 wherein said retorted food product comprises from about 38% to about 45% meat, about 50% jelly, and from about 5% to about 12% gel capsules or tablets.

7. A food product according to claim 2 wherein said retorted food product comprises from about 38% to about 45% fish, about 50% jelly, and from about 5% to about 12% gel capsules or tablets.

8. A food product according to claim 1 wherein said gel capsule is a hydrocollid capsule.

9. A food product according to claim 1 wherein said gel capsule is encapsulated.

10. food product according to claim 9 wherein said encapsulation is gel entrapment.

11. A food product according to claim 9 wherein said gel capsule is encapsulated with a coating.

12. A food product according to claim 4 wherein said gel capsule is encapsulate with two coatings.

13. A food product according to claim 1 wherein said gel capsule comprises from about 0% to about 50% oil, from 0% to about 15% calcium salt, and from 0% to about 3% vitamin-mineral premix on a wet basis.

14. A food product according to claim 13 wherein said calcium salt consists of one of tricalcium phosphate, calcium chloride and calcium sulphate.

15. A food product according to claim 13 wherein said oil consist of one of a vegetable oil, an animal oil, a palm oil, a soya oil, a sunflower oil, pork tallow, and beef tallow.

16. A food product according to claim 1 wherein said food product is a pet food product.

17. A food product according to claim 1 wherein said food product is a human food product.

18. A food product according to claim 1 wherein said food product consists of a chilled product and a gel capsule.

19. A food product according to claim 18 wherein said chilled product consists of at least a yogurt, a mousse, and a créme dessert.

20. A food product according to claim 18 wherein said food product consists of upto 50% gel capsules.

21. A food product according to claim 1 wherein said gel capsule protect nutrients from the outside environment.

22. A food product according to claim 1 wherein said gel capsule has a diameter of about 20 mm.

23. A food product according to claim 1 wherein said gel capsule has a diameter from about 0.1 mm to about 5 mm.

24. A method of producing a food product comprising:
mixing an aqueous solution of alginate, pectate, oil blend, vitamins, minerals, colorants, and flavors in the presence of sequestrant agents to form a stable liquid emulsion;
dropping said stable liquid emulsion into a calcium chloride solution; and
forming an alginate gel capsule.

25. A method of producing a food product according to claim 24 further comprises the step of immersing said gel capsule in a solution consisting of at least one of calcium chloride, alginate, and pectate.

26. A method of producing a food product comprising:
mixing an aqueous solution of alginate, pectate, oil blend, vitamins, minerals, colorants and flavors in the presence of sequestrant agents to form a stable liquid emulsion;
adding at least one of a frozen food ingredient and a dry powder food ingredient;
grinding said liquid emulsion in a calcium sulphate solution utilizing an emulsifier to form a second emulsion;
injecting said second emulsion into a tray or mold for gelation; and
cutting gel capsules.

27. A method of producing a food product according to claim 26 further comprises the step of immersing said gel capsule in a solution consisting of at least one of calcium chloride, alginate, and pectate.
